(19) United States
(12) Patent Application Publication
(10) Pub. No.: US 2025/0156710 A1
(43) Pub. Date: May 15, 2025

(54) System and Method for Ensembling Learners with Highly Variable Class-Based Performance

(71) Applicant: Edammo, Inc., Iowa City, IA (US)

(72) Inventors: Edward Ratner, Stirling, NJ (US); Kallin Carolus Khan, San Francisco, CA (US); Christopher J. Douglas, Coralville, IA (US)

(21) Appl. No.: 18/945,135

(22) Filed: Nov. 12, 2024

Related U.S. Application Data
(60) Provisional application No. 63/597,893, filed on Nov. 10, 2023.

(51) Int. Cl. G06N 3/08; G06N 3/045

(52) U.S. Cl. CPC G06N 3/08; G06N 3/045

(57) ABSTRACT

A model-agnostic method for weighting the outputs of base classifiers in machine learning (ML) ensembles. Class-based weight coefficients are assigned to every output class in each learner in the ensemble. A dense set of coefficients is generated for the models in the ensemble by considering the model performance on each class. The approach can be applied to an ensemble of extreme learning machines (ELMs), which are well suited for this approach due to their stochastic, highly varying performance across classes.

### CROSS REFERENCE TO RELATED APPLICATION

The present application claims the benefit of U.S. Provisional Application No. 63/597,893, which was filed on Nov. 10, 2023.

### FIELD OF THE INVENTION

The present disclosure generally relates to neural networks used to implement models that learn from responsive to feedback. More particularly, the present disclosure is related to ensembles of stochastic machine learning models, such as ensembles of Extreme Learning Machines.

### BACKGROUND

There are numerous tradeoffs between different machine learning; technologies in terms of training requirement and accuracy. This has limited the ability to use neural networks in certain types of end-use applications for classification. Machine learning (ML) offers a wide variety of classifier models designed for specific learning tasks. These models traditionally focus on identifying a single most effective hypothesis for a given task. However, ensemble learning diverges from this path, embracing a collaborative approach. However, these ensemble learning approaches have a variety of problems and drawbacks.

### SUMMARY

A model-agnostic technique is disclosed for weighting the outputs of base classifiers in machine learning (ML) ensembles. In one implementation, a class-based weight coefficients are assigned to every output class in each learner in the ensemble. A dense set of coefficients is generated for the models in the ensemble by considering the model performance on each class. The approach can be applied to different types of base classifiers and even combinations of different classifiers. In one implementation, the base classifiers comprise an ensemble of extreme learning machines (ELMs).

In one implementation, an example method includes: training, in parallel, an ensemble of machine learning models as base classifiers to implement a data classification analysis model; performing a validation test on each trained model in the ensemble using a validation data set; and assigning a class-based weight per each predicted class to each model in the ensemble based on results of the validation test to form a weighted output of the ensemble with a set of dense class-based weights.

The ensemble of machine learning models may comprise ensembles of stochastic machine learning models

In one implementation, the ensemble of machine learning models comprises an ensemble of different types of machine learning model base classifiers.

In one implementation, the ensemble of machine learning models comprises an ensemble of extreme learning models (ELMs). In one implementation, each ELM in the ensemble of ELMs is assigned a different set of ELM parameters to grid an ELM parameter space.

### BRIEF DESCRIPTION OF THE DRAWINGS

The present disclosure is illustrated by way of example, and not by way of limitation, in the figures of the accompanying drawings in which like reference numerals are used to refer to similar elements.

FIG. 1 is a block diagram illustrating a general system using an ensemble of machine learning models in accordance with an implementation.

FIG. 2 is a block diagram illustrating a system using an ensemble of ELMs to implement a model for classification in accordance with an implementation.

FIG. 3 illustrates a server-based implementation of a system to use an ensemble of ELMs to implement a model in accordance with an implementation.

FIG. 4 is a flow chart of a high-level method of class-based weighting in accordance with an implementation.

FIG. 5 is a flow chart of a high-level method of using an ensemble of ELMs in accordance with an implementation.

FIG. 6 is a flow chart of a method of training an ensemble of ELMs in accordance with an implementation.

FIG. 7 is a flow chart of a method forming and using a feature dictionary in accordance with an implementation.

FIG. 8 is a flow chart depicting an example training phase with dense class-based coefficients in accordance with an implementation.

FIG. 9 illustrates an example of the inference phase with dense class-based coefficients in accordance with an implementation.

### DETAILED DESCRIPTION

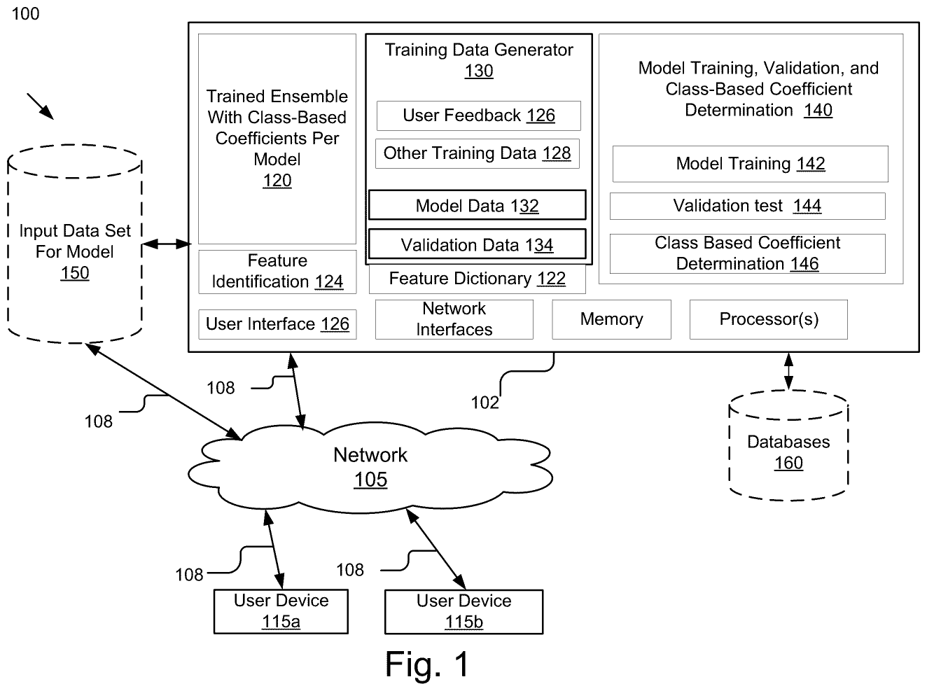

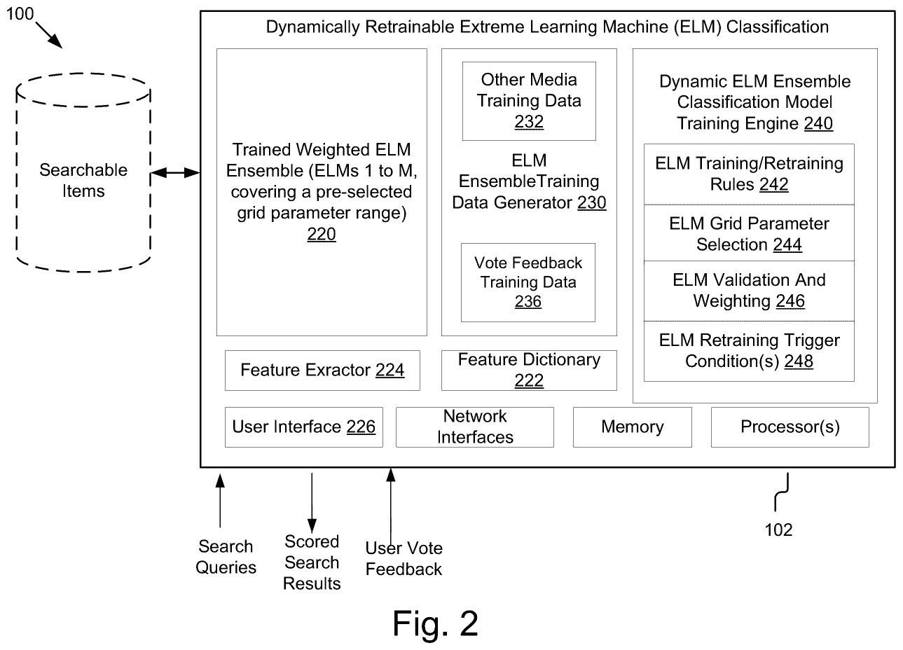

FIGS. 1 and 2 illustrate examples of systems to use ensembles trained with class-based coefficients per model. Ensembles of some kinds of machine learning algorithms can have a class-based performance. An exemplary example is an ensemble of Extreme Learning Machines (ELMs), although other stochastic machine learning models can have variable performance per class, such as random forest (RF) machine learning algorithms. Other potential applications include ensembles of non-stochastic models where the models have different hyperparameter values. In some implementations, an ensemble has a single type of machine learning model, such as an ensemble of ELMs, an ensemble of random forests, etc. However, more generally, an ensemble may include models of different types, such as an ensemble of ELM and RF models.

In one implementation, a method of solving classification problems utilizes a weighted ensemble of machine learning models in which there are class-based weight coefficients per model predicted class.

In one implementation, there are dense class-based weights.

In one implementation, each model in the ensemble is trained with a training data set. In a validation step, there is a validation data set. An aspect of the validation step includes determining a class-based weighting coefficient per each model predicted class. During an inference step, each model in the ensemble makes a prediction, which is weighted per class by the determined class-based weighting coefficient per predicted model. As discussed below in more detail, the class-based coefficients can be determined in various ways, including an accuracy technique or a least squares technique.

### Examples of Determining Weights Per Model Predicted Class

In one implementation, an ensemble of machine learning models is used for classification in a scenario in which there is a high potential variability in the performance of different classes for different models. For the purposes of illustration, the ensemble may be an ensemble of ELMs, although more generally the ensemble may include RF models, or even be an ensemble having both ELM and RF types.

Consider an example in which class-based ensembling is utilized. The application of the ensemble may be a classification problem where a sample needs to be classified into one of k classes: 1, . . . , k.

In the ensembling paradigm, the training data is split into model training data and validation data, which is used to determine weights for the ensemble. For the purposes of illustration, assume there are m models (I(x)) trained on the model training data.

The general ensemble formula is E (x)=

$${\sum }_{i} {a}_{i} {l}_{i} ( x ) / {\sum }_{i} {a}_{i}$$

Where the weights ai are determined based on the validation set.

In standard ensembling, the weights a are constant and in the standard approach are set by the accuracy of model lᵢ on the validation set. For inference prediction, the prediction is viewed as a vector prediction. As a consequence, each class j represented as a vector (0, 0, . . . , 1, . . . 0) where the 1 is in the jth place. Each model i that predicts class j, contributes its weight to the vote for class j.

In the standard approach, at the end of computation, the class with the highest weight is the predicted class. In the standard approach, the normalized total weights can also be used as probabilities for each class.

Consider now a new class-based approach in which the weight of model ai depends on the prediction of model i. In particular, there is a different weight for every predicted class j for model i.

In a validation step, one strategy is to set a i, j to the accuracy of the model when predicting class j in validation. This means that the fraction of actual class j samples over the total number of class j predicted.

An alternate strategy in validation is to formulate this as a non-negative least squares problem. In that case, the problem is formulated as a kN×m left hand side matrix where N is the number of samples in validation. The right-hand side is a kN×1 vector. Each sample contributes k rows where the entry at position (j,i) is a _{i, j} multiplied by the model ith prediction for that sample. The result is 1 if it is class j and 0 otherwise. The right-hand side consists of N groups of rows. The entry is m if the sample is the class j and 0 otherwise.

In inference, each model is evaluated on the test sample. Based on its prediction of class, the appropriate coefficient is chosen and the ensembling proceeds as before.

### Training/Retraining

In one implementation, a human in the loop provides feedback on the results of the model. In the case of a classification model, a human user can provide feedback on the accuracy of the scoring performed by the model by voting on search result items. The votes are used to form positive/negative training data.

Consider, as a non-limiting example, an ELM implementation. As ELMs can be rapidly trained, the ELM ensemble can be trained in parallel when a search query is initiated, using the same training data. The ELM ensemble can also be retrained based on voting data. In some implementations, a feature dictionary is formed from feature data extracted from search queries. Feature data from a query may be used to train an ELM ensemble.

However, more generally an ELM ensemble supports rapid training/retraining of an ELM ensemble to support classification.

### General Ensemble System Example

FIG. 1 is a high-level diagram of a system 102 to use a trained weighted ensemble to implement a model in accordance with an implementation. At a high level, the major components include a trained ensemble model 120, a training data generator 130, and a dynamic model training engine 140. The model operates on an input data set 150 to generate a model output. However, using an ensemble permits each individual model in the ensemble to have variations in parameters.

For example, for an ELM ensemble implementation there may be variation in parameters such as a number of neurons, variations in regularization coefficients (e.g., L1 and L2 coefficients), and variations in initialization of random weights in a first layer. This may be implemented during training by a parameter grid selection module 144. The ensemble models may be used to generate a weighted output model, which is weighted based on a result of a validation test 146.

In one implementation, the training data includes general training 128 and user feedback 126. The training data may include model data 132 and validation data 134. The ensemble of machine learning models may be trained based on feature data 124 built up in a feature dictionary 122 from feature data provided by a feature identification module 124.

Model training, validation, and class-based coefficient determination 140 supports model training 142, validation 144, and class-based weighting coefficient per predicted class 146 as previously discussed.

FIG. 1 illustrates a general system that may be implemented on an enterprise network, as a web-based Internet service, or a cloud-based or cloud-supported service. Individual users may use a user device 115 to access a UI to submit problems for the system 102 to solve using the trained ensemble 120. Individual components may, for example, communicate via a network 105 and individual communication links 108. Individual users may also submit feedback, which in the simplest case could be votes. Votes may be as simple as yes/no type votes (e.g., positive or negative) although more generally other schemes could be used to acquire user feedback (e.g., providing a user with a ratings scale).

The system 102 may be implemented as computer software code with hardware supports such as network interface, memory, processor(s), and databases 160. The system 102 may be implemented in various ways. As some possibilities, it may be implemented as a server-based system operating in an enterprise environment, a web-based network service, via a cloud-based, or via a cloud-assisted service.

One application of the system 102 is to perform classification (scoring).

### ELM Ensemble System Example

An illustrative but non-limiting example of class-based weighting approach is for an ensemble of Extreme Learning Machines. An individual Extreme Learning Machine (ELM) is a particular type of feedforward neural network that has various advantages and disadvantages compared with other machine learning approaches. A review of ELM technology is provided in the article by Mustafa Abbas Abbod Albadr et al, “Extreme Learning Machine: A Review”, International Journal of Applied Engineering Research, ISSN 0973-4562 Vol. 12, No. 14 (217), pp 4610-4623, the contents of which are hereby incorporated by reference.

Additional background on ELMs on determining weights is found in a paper by G. B. Huang, et al, “Extreme Learning Machine: Theory and Applications,” Neurocomputing, 70(10:489-501 (2006), the contents of which are hereby incorporated by reference.

ELMs have many different applications, including classification. See, e.g., G. B. Huang, et al., “Extreme Learning Machine for Regression and Multiclass Classification,” IEEE Transactions on Systems, Man, and Cybernetics-Part B, Cybernetics, 42(2): 513-529 (2012).

ELMs have been used for applications such as regression, classification, sparse coding, and compression features learning. An ELM may be implemented to have a single layer of hidden nodes corresponding to a single layer feedforward network. In ELM, the input layer weights are randomly assigned and the output layer weight may be obtained by using a generalized inverse of the hidden layer output matrix.

ELMs typically have a single hidden layer of nodes, although some forms of ELMs have more than one hidden layer of nodes. The parameters of hidden nodes (not just the weights connecting inputs to hidden nodes) need not be tuned.

One aspect of ELMs is that in most cases, the output weights of hidden nodes are learned in a single step. ELMs can be trained extremely quickly compared with many other types of neural networks.

There is a vast number of academic papers describing ELMs theory, the applications of ELMs, and variations on ELM. However, while ELMs are fast to train, they are also known to have problems achieving consistently high accuracy. That is, an individual ELM used as a single hidden layer feedforward network may achieve a high accuracy. But accuracy with consistency can be a barrier in many applications.

An ensemble of machine learning models may grid a parameter space. For example, for an ensemble of ELMs the individual ELMs in the ensemble may grid a parameter space for the ELMs. The ensemble of ELMs may be used to achieve rapid training of a model with consistently high accuracies

The gridding of the parameter space may be chosen to achieve a consistently high accuracy of the weighted ensemble of trained ELMs.

As illustrated in FIG. 2, the system 102 may be implemented to receive user search queries, return scored search results (e.g., in a ranked list), and receive user vote feedback on individual search results. In this example, a trained ELM ensemble 220 outputs a weighted score. In one implementation, each ELM implements a different set of parameters to grid a parameter space associated with ELM performance/accuracy. A feature extractor 222 extracts features from input search queries. The feature extractor may, for example, extract features from text and ignore irrelevant words. In some implementations, the extracted features are added to a feature dictionary 224 that is used to build up a set of features over many search queries.

In one implementation, the ELM ensemble 220 is trained based on extracted features and the feature dictionary. Vote feedback data 234, if available, may also be used. The training engine 240 includes a grid parameter selection module 244 to grid a parameter space. A validation and a weighting module 246 performs a validation test on each trained ELM based on a validation test and weights each trained ELM based on the validation test. General rules for training or retraining the ELM ensemble 242 may be selected, such as rules for using extracted features and features in the feature dictionary during training.

Additionally, specific conditions for triggering training/retraining of the ELM ensemble 248 may be provided. As one example, training of the ELM ensemble may be triggered for each new search query. However, there may be scenarios where a new search query is merely a minor variation of earlier search queries such that retraining would be unlikely to change search results. In some implementations, a user may be provided with options to request reevaluation of their search query after they have provided one or more votes. The retraining may thus be triggered in response to a user command. However, other options are possible, such as automatically performing retraining after a selected number of user votes.

In a general use scenario, individual users utilize a user device 115 to enter search queries. This results in scoring the searchable items and may include presenting the scored items in a ranked order. The score may also optionally be displayed. An individual user who submitted a query may vote on one or more of the search results. The simplest voting system is a positive or negative (thumbs up or thumbs down) vote about an individual item. However, more generally, a user can vote on as many items as they wish. Other types of voting systems can also be used, but a thumbs up/thumbs down voting system is easiest to implement.

The votes are used as feedback training data. The retraining of the ELM ensemble model 104 can be in different ways. For example, a user interface may provide a button for a user to request retraining of the model (e.g., a “reevaluate” button). Other conditions could be selected to trigger retraining of the model, such as after a pre-selected number of votes. When the ELM ensemble model is retrained, the training engine 102 uses the votes as an additional source of training data. The features extracted from queries by a feature extractor stored in the feature dictionary may be used to train the ensemble of ELMs. In the training of the ensemble of ELMs, key parameters in a parameter space are gridded, as will be discussed below in more detail. Each trained ELM in the ensemble is tested using a validation data set, with the validation results being used to assign a weight to each ELM in the ensemble.

### Server-Based System Example

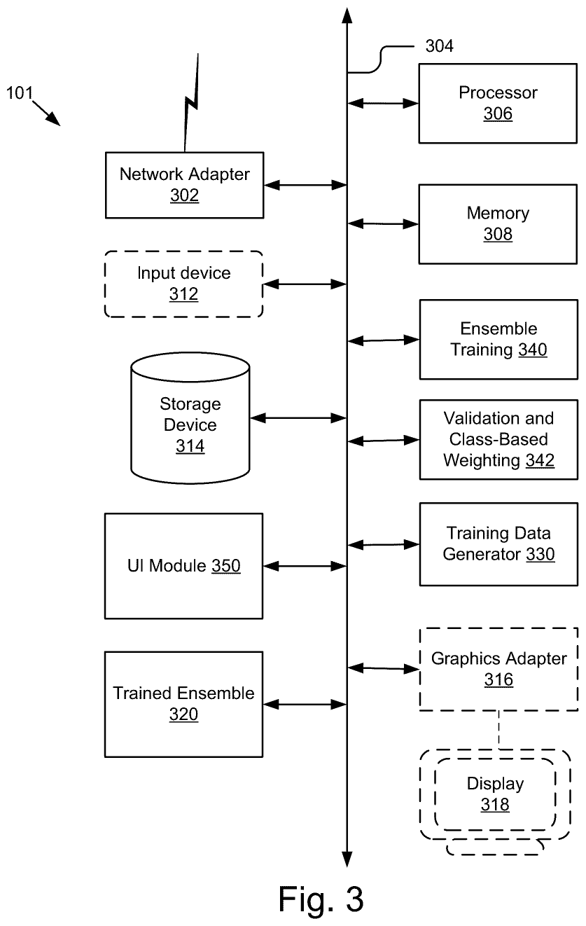

Referring to FIG. 3, while the system may be implemented in different ways, it can be implemented as a server-based system having a data bus 304, processor 306, memory 308, storage device 314, input device 312, network adapter 302, and optional graphics adapter 316 and display 318. Memory units 320, 330, 340, and 350 may store computer program instructions for implementing a UI, using the trained ensemble, training the ensemble, and generating training data.

It will be understood that in some implementations the processor is a Machine Learning/Artificial Intelligence ASIC (Application Specification Integrated Circuit). The ML/AI ASIC may include custom hardware and processors for AI/ML applications.

### Example High Level Method for Different Model Types

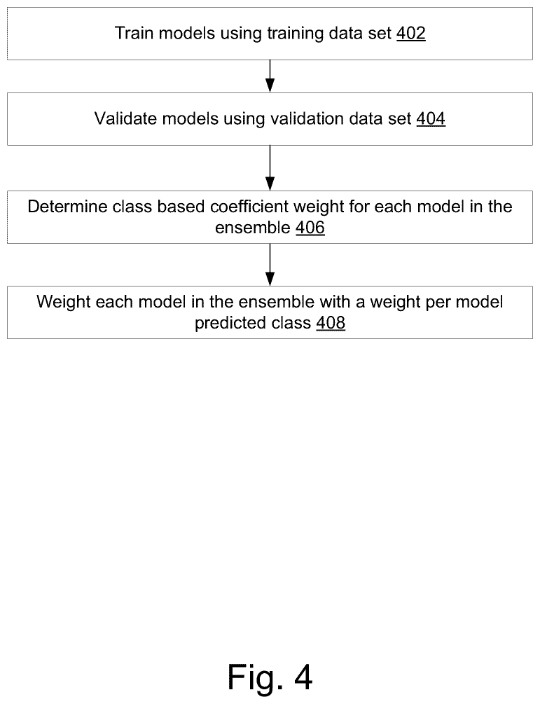

FIG. 4 is a high-level flow chart illustrating aspects of class-based coefficient weights. In block 402, models in the ensemble are retrained using a training data set. In block 404, the models are validated using a validation set. In block 406, a class-based coefficient weight is determined for each model predicted class in the ensemble. As previously discussed, a variety of techniques may be used to determine the weights. In block 408, each model is weighted in the ensemble with the determined weights.

### Example Methods for ELM Ensemble

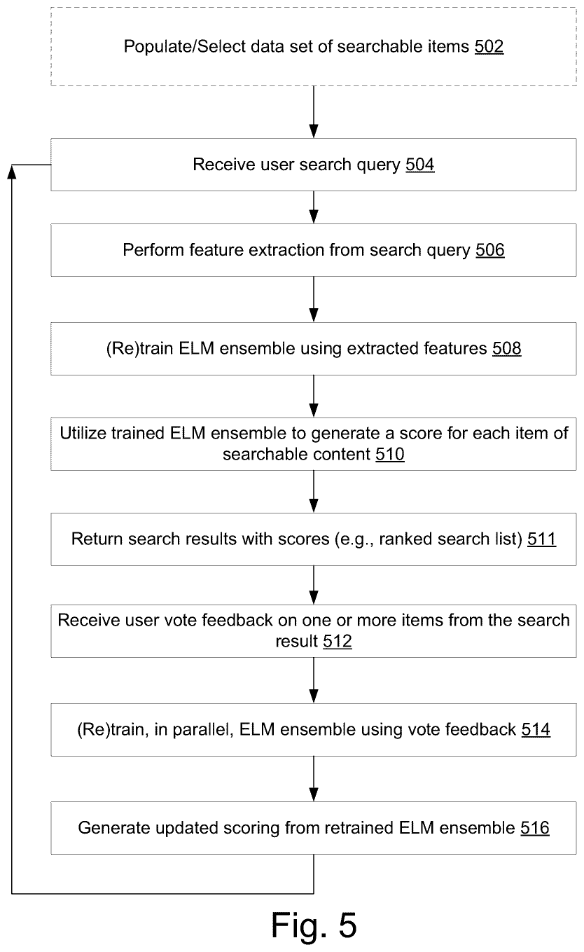

FIG. 5 is a flow chart of a general method for using a trained ELM ensemble to score searchable items in accordance with an implementation. In block 502 a selection is made of a data set of searchable items. This may, for example, be a corporate database or a selection of web services that provide access to media items. In block 504, a user search query is received. In block 506, features are extracted from the search query. In block 508, the ELM ensemble is trained using the extracted features. The trained ELM ensemble is used in block 510 to generate a score for each item of searchable media content. The score could be provided to a user in many different ways. For example, as illustrated in block 511, a ranked search result may be returned to the user. Users are provided with the option to vote on individual search results. The system receives user vote feedback for one or more items from the search result in block 512. For example, users could be asked to vote for each media item whether it was useful or whether the user wanted to see more search results like it. For example, a user might vote on the first 10 search results in a ranked list of search results. The simplest voting system is a simple yes/no vote, which corresponds to positive and negative training data.

In block 514, the ELMs in the ensemble are retrained in parallel. Each ELM is trained with the same feature set, the same voting data, etc. In block 516, an updated scoring is performed using retrained ELM ensemble.

The process can optionally be performed over multiple search queries, if desired. For example, in the case of resumes, a recruiter may make minor variations of a search query to find a candidate. Over the course of several search queries for a candidate, the feature dictionary will build up, along with positive and negative votes for individual resumes.

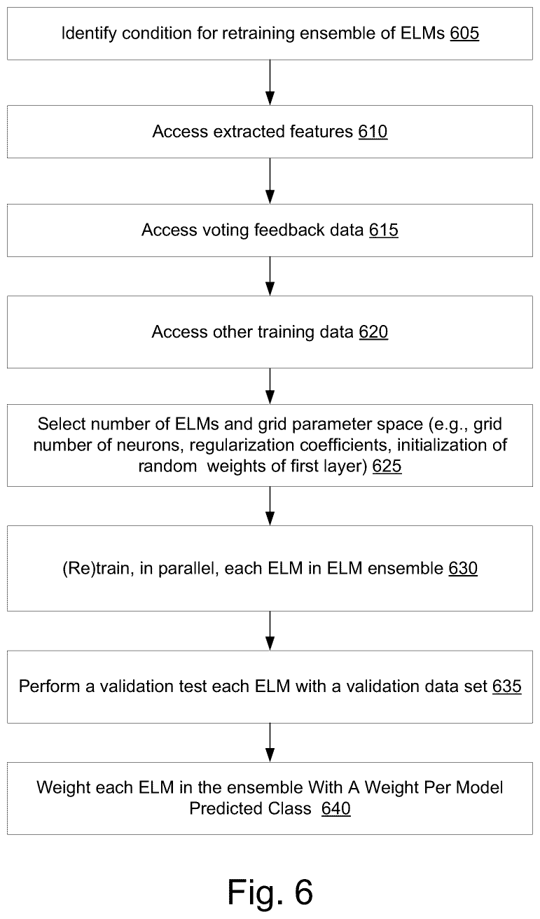

FIG. 6 is a flow chart illustrating a method for training/retraining the ELM ensemble. In block 605, a condition is identified for training/retraining the ensemble of ELMs. For example, the condition might be the receipt of a new search query. As another example, a user may be provided the option to request reevaluation after submitting one or more votes.

In block 610, extracted features are accessed from which the ensemble of ELMs is trained. More generally, the features may come from a feature dictionary built up from features extracted over a series of search queries. If there is voting feedback data, this may be accessed in block 615. Other training data/sample data that is available is accessed in block 620. The ELM ensemble has a variation in ELM parameter that grids a parameter space. This could be implemented in block 625 with a pre-selected number of ELMs in the ensemble along with a pre-selected gridding of the parameter space in terms of factors such as a number of neurons, regularization coefficients, and initialization of random weights in a first layer. The gridding could be “fine” enough to ensure that at least one ELM in the ensemble will provide accurate results. However, more generally, the gridding could be optimized based on empirical studies, recent search result validation test, etc.

In block 630, each ELM in the ensemble is trained in parallel. The data loading can be performed in parallel and the ELM supports fast training.

In block 635, a validation test is performed for each trained ELM in the ensemble using a validation data set. This results, effectively, in a confidence score for each ELM. In block 640, each ELM is weighted based on the results of its validation test results. This results in a weighted score. The use of a weighted score helps to achieve consistent accuracy in model results compared with using a single ELM.

### Feature Dictionary Method

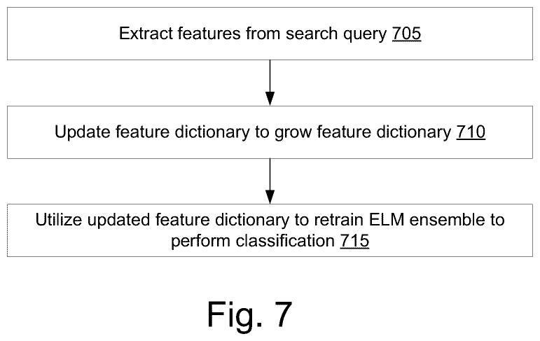

FIG. 7 is a flow chart of a method of using a feature dictionary in accordance with an implementation. In block 705, features are extracted from a current search query. In block 710, the feature dictionary is updated using the extracted features. In block 715, the updated feature dictionary is used to retrain the ELM ensemble to perform classification.

One of ordinary skill in the art would understand that the gridding strategy could be optimized for particular problems and for specific aspects of a training set. Using the same gridding strategy of the ELM parameter space for a wide variety of problems is not ideal in practice. In other words, determining an optimum gridding strategy is problem dependent and also depends on aspects of the training set.

The gridding of the ELM parameter space may be customized for a particular problem and for aspects of the training set. However, there may also be other practical considerations on computing and memory resources in order to quickly train/retrain the ensemble of ELMs within time frames that provide an acceptable user experience. Thus, the gridding strategy might also, for example, also take into consideration keeping the number, M, of ELMs in the ELM ensemble within a reasonable number that need be trained/retrained.

As previously discussed, the ELM ensemble generates a score. In the context of a classification problem, the score (or corresponding probability) is a natural outcome of using an ELM ensemble in which learner votes with its weight. This aspect of the ELM ensemble facilitates using the score in classification problems.

### Additional Dense Class Based Weight Example

As previously discussed, in one implementation, class-based weight coefficients are assigned to every output class in each learner in the ensemble. This is particularly useful when the base classifiers have highly variable performance across classes. This method generates a dense set of coefficients for the models in the ensemble by considering the model performance on each class. That is, there are dense class-based weights. An ensemble of extreme learning machines (ELMs is well suited for this approach due to their stochastic, highly varying performance across classes.

In addressing classification challenges, an example method introduces a novel approach: a weighted ensemble of extreme learning machine (ELM) models endowed with unique class-based weight coefficients. These coefficients are assigned to every class within the model, providing a tailored approach to class representation. The process begins with each model undergoing training and validation. During validation, the method calculates a class-based weighting coefficient for each class specific to each model. This coefficient is derived by evaluating the model's performance on the validation set, ensuring that it accurately reflects its efficacy in class prediction.

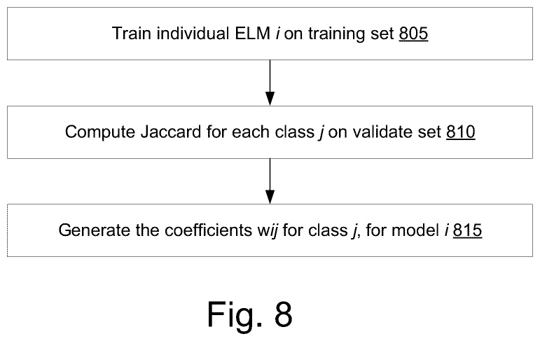

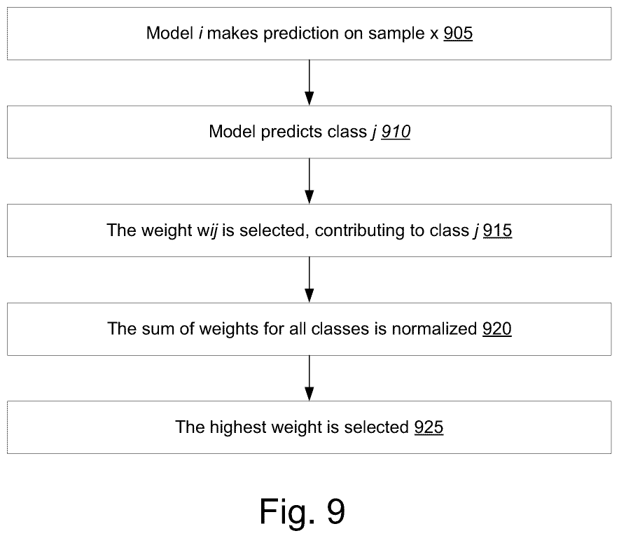

FIG. 8 is a flow chart depicting an example training phase. In block 805, each individual ELM is trained on a training data set. In block 810, the Jaccard index (a well-known statistical coefficient of similarity and diversity of sample sets) is computed for class j on a validation set. In block 815, the coefficients wij are generated for class j, for model i. This approach of determining weights during validation by setting them equal to the Jaccard index when predicting class j yields a dense set of class-based weights. Subsequently, in the inference phase, each model within the ensemble contributes its prediction. These predictions are not treated uniformly; instead, they are weighed according to the dense class-based weight coefficient associated with the predicted class of each model. This nuanced weight mechanism ensures that the predictive contribution of each model is adjusted based on its demonstrated proficiency in classifying each class. The determination of these class-based coefficients is an important aspect with an example process. FIG. 9 illustrates an example of the inference phase. In block 905, Model i makes a prediction on sample x. In block 910, the model predicts class j. In block 915, the weight wij is selected, contributing to class j. In block 920, the sum of weights for all classes is normalized. In block 925, the highest weight is selected.

In this paradigm, the initial step involves partitioning the training data into two subsets: training and validation. This validation set plays a crucial role in fine-tuning the ensemble by determining the optimal weights for each model in the ensemble. Consider an ensemble consisting of m models, each trained on its respective subset of the training data. The effectiveness of the ensemble is encapsulated in the general formula for ensemble output given by

$$E ( x ) = arg {max}_{j} {\sum }_{i = 1}^{m} {w}_{ij} {X}_{A} ( {C}_{i} ( x ) = j ) . \vert$$

In this formula, E(x) represents the ensemble's prediction for input x. The term Ci(x) is the prediction of the ith model in the ensemble for the input x, and the wij terms are the weights assigned to each model's prediction. These weights are set according to the validation performance, and the ensemble can effectively leverage the strengths of each model. In conventional ensemble methods, the weights are constant, typically determined by the accuracy of each model on the validation set. This approach treats predictions as vector predictions when making inference predictions; that is, each model predicts whether the test sample is a member of each class. Consequently, for class j, the prediction is represented as a vector with the format (0, . . . , 1, . . . , 0), where the ‘1’ is positioned in the jth place. In this scenario, when model i predicts class j, it contributes its coefficient to class j; for all other classes, the value is zero.

Ultimately, the class receiving the highest cumulative weight is deemed the predicted class. Moreover, the normalized total weights can be interpreted as class probabilities. In our new class-based ensembling approach, we introduce a dynamic element where the weight wij of the model varies depending on its prediction. In this framework, each predicted class j for model i has a distinct weight. During validation, one strategy to determine these weights, ai and j, is to set them equal to the model's Jaccard index when predicting class j. This yields a dense set of coefficients, with each model typically having a non-zero coefficient for each class. This strongly contrasts against boosting-like approaches that typically solve a linear system resulting in sparse coefficients. In the inference phase, each model is evaluated on the test sample. The appropriate coefficient is selected based on its class prediction, and the ensemble computation proceeds similarly to the standard approach. We demonstrate the advantage of our approach in the context of an ELM ensemble implementation as determined in the Extreme AutoML methodology.

### Experimental Results

Additional experimental results are described in the article “Ensemble Learning with Highly Variable Class-Based Performance,” in Mach. Learn. Knowl. Extr. 2034, 6, 2149-2160, the contents of which are hereby incorporated by reference.

As previously discussed, an implementation uses class-based weight coefficients assigned to every output class in each learner in the ensemble. This is particularly useful when the base classifiers have highly variable performance across classes. A method is employed to generate a dense set of coefficients for the models in our ensemble by considering the model performance on each class. The results of this approach were compared to the commonly used ensemble approaches like voting and weighted averages. In addition, we compare our approach to class-specific soft voting (CSSV), which was also designed to address variable performance but generates a sparse set of weights by solving a linear system. An approach was experimentally tested that was applied to an ensemble of extreme learning machines (ELMs), which are well suited for this approach due to their stochastic, highly varying performance across classes.

The experimental results illustrate the superiority of the approach by comparing its performance to that of simple majority voting, weighted majority voting, and class-specific soft voting using ten popular open-source multiclass classification datasets.

### Applications to Non-ELM Ensembles

In one implementation, the effectiveness of this approach is illustrated using extreme learning machines (ELMs) as the base classifier; however, this approach may be implemented with ensembles of stochastic machine learning models and may, for example, be applied to random forests.

Examples of ELMs are described due to their highly varied performance caused by the generation of random hidden nodes. The non-correlated errors of ELMs can be leveraged in ensemble learning.

### Alternate Implementations

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware.

Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation or an implementation containing both software and hardware elements. In some implementations, the technology is implemented in software, which includes, but is not limited to, firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies, and other aspects are not mandatory or significant, and the mechanisms that implement the present techniques and technologies or its features may have different names, divisions, and/or formats. Furthermore, the modules, routines, features, attributes, methodologies, and other aspects of the present technology can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A method, comprising:
training, in parallel, an ensemble of machine learning models as base classifiers to implement a data classification analysis model;
performing a validation test on each trained model in the ensemble using a validation data set; and
assigning a class-based weight per each predicted class to each model in the ensemble based on results of the validation test to form a weighted output of the ensemble with a set of dense class-based weights.

2. The method of claim 1, wherein ensemble of machine learning models comprises ensembles of stochastic machine learning models.

3. The method of claim 1, wherein the ensemble of machine learning models comprises an ensemble of different types of machine learning model base classifiers.

4. The method of claim 1, wherein the ensemble of machine learning models comprises an ensemble of extreme learning models (ELMs).

5. The method of claim 1, wherein there is a different weight a for each predicted class j for model i.

6. The method of claim 5, wherein each weight is selected based on the accuracy of the ELM model when predicting class j in validation.

7. The method of claim 6, wherein a non-negative least squares algorithm is used to determine each weight.

8. The method of claim 4, wherein each ELM in the ensemble of ELMs is assigned a different set of ELM parameters to grid an ELM parameter space.

9. The method of claim 8, wherein the parameter space that is gridded includes a number of neurons, regularization coefficients, and initialization of random weights.

10. The method of claim 4, further comprising re-training the ensemble of ELMs using additional training data from user feedback, performing the validation test on each ELM in the ensemble of ELMs, and re-weighting the ensemble of ELMs.

11. The method of claim 10, further comprising re-training the ensemble of ELMs using additional training data from user feedback, performing the validation test on each ELM in the ensemble of ELMs, and re-weighting the ensemble of ELMs.

12. The method of claim 11, where the user feedback comprises voting on scored items.

13. A computer-implemented method, comprising:
receiving a user query for searchable items;
extracting features from the user query;
training an ensemble of Extreme Learning Machines (ELMs) to score a collection of searchable items based at least in part on the extracted features and available training data, each ELM being assigned a different set of ELM parameters to grid an ELM parameter space;
performing a validation test on each trained ELM;
determining a class-based weight per predicted class for each ELM based on results of the validation test;
scoring searchable items using the weighted output of the ensemble of ELMs; and
returning search results to the user query based on the scoring of the searchable items.

14. The method of claim 13, wherein there is a different weight a for each predicted class j for model i.

15. The method of claim 14, wherein each weight is selected based on the accuracy of the ELM model when predicting class j in validation.

16. The method of claim 13, wherein a non-negative least squares algorithm is used to determine each weight.

17. The method of claim 14, further comprising receiving user feedback on the scoring, using the user feedback as an additional form of training data, re-training the ensemble of ELMs, performing the validation test on the retrained ensemble of ELMs, re-weighting the ensemble of trained ELMs based on the validation test.

18. The computer-implemented method of claim 17, further comprising re-scoring the searchable media items using the re-weighted and re-trained ensemble of trained ELMs.

19. The computer-implemented method of claim 17, wherein the parameter space that is gridded includes a number of neurons, regularization coefficients, and initialization of random weights.

20. The computer-implemented method of claim 17, wherein user feedback comprises positive votes and negative votes.

21. The computer-implemented method of claim 17, wherein the method further comprises generating a feature dictionary from extracted features and using the feature dictionary in at least one subsequent search query to train the ensemble of ELMs.

22. A system, comprising:
a processor and a memory to execute computer program code to implement a method, including:
training, in parallel, an ensemble of machine learning models as base classifiers to implement a data classification analysis model;
performing a validation test on each trained model in the ensemble using a validation data set; and
assigning a class-based weight per each predicted class to each model in the ensemble based on results of the validation test to form a weighted output of the ensemble with a set of dense class-based weights.

23. The system of claim 22, wherein the ensemble of machine learning models comprises ensembles of stochastic machine learning models.

24. The system of claim 22, wherein the ensemble of machine learning models comprises an ensemble of different types of machine learning model base classifiers.

25. The system of claim 22, wherein the ensemble of machine learning models comprises an ensemble of extreme learning models (ELMs).

26. The system of claim 25, wherein there is a different weight a for each predicted class j for model i.

27. The system of claim 26, wherein each weight that is selected is based on the accuracy of the ELM model when predicting class j in validation.

28. The system of claim 26, wherein a non-negative least squares algorithm is used to determine each weight.

29. The system of claim 25, wherein each ELM in the ensemble of ELMs is assigned a different set of ELM parameters to grid an ELM parameter space.

30. The system of claim 29, wherein the parameter space that is gridded includes a number of neurons, regularization coefficients, and initialization of random weights.

31. The system of claim 26, wherein the processor is an Application Specific Integrated Circuit (ASIC) with machine learning hardware.
